(19) United States
(12) Patent Application Publication
(10) Pub. No.: US 2026/0080903 A1
(43) Pub. Date: Mar. 19, 2026

(54) MULTIMEDIA MATERIAL EDITING AND PROCESSING METHOD, ELECTRONIC DEVICE AND STORAGE MEDIUM

(71) Applicant: Beijing Zitiao Network Technology Co., Ltd., Beijing (CN)

(72) Inventors: Qi JIANG, Beijing (CN); Chengcai GAO, Beijing (CN); Xiaoling FU, Beijing (CN); Junjie LIU, Beijing (CN); Hai HE, Beijing (CN)

(21) Appl. No.: 19/246,565

(22) Filed: Jun. 23, 2025

(30) Foreign Application Priority Data
Sep. 19, 2024 (CN) 202411311815.1

(51) Int. Cl. G11B 27/031

(52) U.S. Cl. CPC G11B 27/031

(57) ABSTRACT

The present disclosure provides a multimedia material editing and processing method, an electronic device and a computer readable storage medium. The method includes: determining editing state description information that is stored corresponding to a third editing state when a target editing task is switched from a first editing state to a second editing state, wherein the third editing state is a first type of editing state that is not triggered after the second editing state among editing states in a preset editing state sequence; there is at least one reference editing state in the preset editing state sequence, editing state description information that is stored corresponding to which belongs to a second type of editing state description information; and presenting an editing effect corresponding to the second editing state, according to editing state description information that is stored corresponding to the third editing state.

### CROSS-CITATION TO RELATED APPLICATION

This application claims the priority to and benefits of the Chinese Patent Application, No. 202411311815.1, which was filed on Sep. 19, 2024. The aforementioned patent application is hereby incorporated by reference in its entirety.

### TECHNICAL FIELD

Embodiments of the present disclosure relate to the technical field of computer software, and in particular, to a multimedia material editing and processing method and apparatus, an electronic device, and a storage medium.

### BACKGROUND

In a multimedia material editing process, undoing and redoing a last editing operation are commonly used functions. At present, there is an editing result after each editing operation of multimedia materials. In order to switch between editing results in different editing stages, a data backup will be generated for the editing result after each editing operation, and the editing result can be accurately restored according to any data backup. However, such operations bring about a large amount of redundant memory occupation, resulting in a sudden increase in the memory occupation required in the multimedia material editing process; especially when there are many editing operations on the multimedia materials, the memory occupation will increase linearly, and even lead to crashes due to excessive memory.

### SUMMARY

Embodiments of the present disclosure provide a multimedia material editing and processing method and apparatus, an electronic device a storage medium, in order to solve the problem that a large amount of redundant memory occupation is caused by editing data during performing the editing operations, which leads to a sudden increase in the memory occupation required in the multimedia material editing process.

According to a first aspect, an embodiment of the present disclosure provides a multimedia material editing and processing method. The method comprises:
determining editing state description information corresponding to a third editing state when a editing task is switched from a first editing state to a second editing state, wherein the third editing state is a first type of editing state that is not triggered after the second editing state among editing states in a preset editing state sequence, the editing task is a multimedia material editing task, and the preset editing state sequence is used for recording different editing states triggered in sequence in the editing task in an orderly manner; there is at least one reference editing state in the preset editing state sequence, editing state description information corresponding to the reference editing state belongs to a second type of editing state description information, and the second type of editing state description information is used for indicating an editing state difference between the second type of editing state and an adjacent editing state triggered before the second type of editing state in the preset editing state sequence; and
presenting an editing effect corresponding to the second editing state, according to editing state description information corresponding to the third editing state.

According to a second aspect, an embodiment of the present disclosure provides a multimedia material editing and processing apparatus, which comprises:
a determination module configured to determine editing state description information corresponding to a third editing state when a editing task is switched from a first editing state to a second editing state, wherein the third editing state is a first type of editing state that is not triggered after the second editing state among editing states in a preset editing state sequence, the editing task is a multimedia material editing task, and the preset editing state sequence is used for recording different editing states triggered in sequence in the editing task in an orderly manner; there is at least one reference editing state in the preset editing state sequence, editing state description information corresponding to the reference editing state belongs to a second type of editing state description information, and the second type of editing state description information is used for indicating an editing state difference between the second type of editing state and an adjacent editing state triggered before the second type of editing state in the preset editing state sequence; and
a processing module configured to present an editing effect corresponding to the second editing state, according to editing state description information corresponding to the third editing state.

According to a third aspect, an embodiment of the present disclosure provides an electronic device, which comprises:
at least one processor; and
a storage apparatus configured to store at least one program, wherein
the at least one program, when executed by the at least one processor, cause the at least one processor to implement the multimedia material editing and processing method according to any of the above embodiments.

According to a forth aspect, an embodiment of the present disclosure provides a non-transitory computer-readable storage medium, which comprises computer-executable instructions, wherein the computer-executable instructions, when executed by a computer processor, perform the multimedia material editing and processing method according to any of the above embodiments.

According to the technical solution of the embodiment of the present disclosure, the preset editing state sequence can record different editing states triggered in sequence in the editing task in an orderly manner, which makes it convenient to perform editing state switching when performing editing operations on the editing task. When the editing results in different editing states are switched, a data backup will be generated for the editing result corresponding to the editing state after each editing operation, so that the editing result of any editing state can be accurately restored according to the data backup of the editing state later. However, this causes a large amount of memory to be occupied by the data backup in the editing state. To this end, in this solution, at least one of the second type of editing state is set in the preset editing state sequence, and the editing state description information corresponding to the second type of editing state is used for indicating a difference between the editing state and a previous adjacent editing state, so that the data backup storage amount of each editing state can be effectively reduced due to the fact that only the description information difference between the editing states needs to be stored, instead of the complete description information of each editing state. In this way, when switching from the first editing state to the second editing state, the editing state description information corresponding to the third editing state is determined first, the third editing state is the first type of editing state that is not triggered after the second editing state in the preset editing state sequence, and the first type of editing state description information has the ability to independently present the corresponding editing effect. Furthermore, in combination with the editing state description information corresponding to at least one of the second type of editing state in the preset editing state sequence, the editing result corresponding to the second editing state can be quickly calculated and updated, thereby enabling not only rapid switching between editing states, but also rapid restoration of the previous editing state for modification. Meanwhile, when storing the data backup corresponding to the editing state, it is not necessary to store the data backup of each editing state in full, but only the difference in the description information between editing states needs to be stored, so that a large amount of redundant memory occupation is reduced and the problem of crashes caused by a sudden increase or even excessive memory occupation in the multimedia material editing process is avoided as much as possible.

It should be understood that what is described in this section is not intended to identify key or important features of the embodiments of the disclosure, nor is it intended to limit the scope of the disclosure. Other features of the present disclosure will be readily understood from the following description.

### BRIEF DESCRIPTION OF DRAWINGS

The above and other features, advantages, and aspects of embodiments of the present disclosure will become more apparent from the following detailed description when taken in conjunction with the accompanying drawings. Throughout the drawings, the same or similar reference numbers refer to the same or similar elements. It should be understood that the drawings are schematic and that components and elements are not necessarily drawn to scale.

FIG. 1 is a flowchart of a multimedia material editing and processing method according to an embodiment of the present disclosure;

FIG. 2 is a schematic diagram of pages for performing editing operations on multimedia materials according to an embodiment of the present disclosure;

FIG. 3 is a schematic diagram for storing and recording editing states after performing editing operations on the multimedia materials, according to an embodiment of the present disclosure;

FIG. 4 is a schematic diagram of performing an editing state switching for a target editing task according to an embodiment of the present disclosure;

FIG. 5 is a flowchart of another multimedia material editing and processing method according to an embodiment of the present disclosure;

FIG. 6 is a schematic diagram of editing states when an editing state switching is performed for a target editing task according to an embodiment of the present disclosure;

FIG. 7 is another schematic diagram of editing states when an editing state switching is performed for a target editing task according to an embodiment of the present disclosure;

FIG. 8 is a schematic diagram of generating an editing state difference by comparing editing task information according to an embodiment of the present disclosure;

FIG. 9 is a structural schematic diagram of a multimedia material editing and processing apparatus according to an embodiment of the present disclosure; and

FIG. 10 is a structural schematic diagram of an electronic device for implementing the multimedia material editing and processing method according to an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “include/comprise ” and variations thereof used therein are open-ended inclusion, namely “ include/comprise but not limited to ”. The term “based on” refers to “at least partially based on”. The term “an embodiment” means “at least one embodiment”; the term “another embodiment” means “at least one another embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that otherwise explicitly stated in the context, it should be understood as “one or more”.

The names of messages or information exchanged between a plurality of apparatuses in the embodiments of the present disclosure are used for illustrative purposes only, and are not indicated to limit the scope of these messages or information.

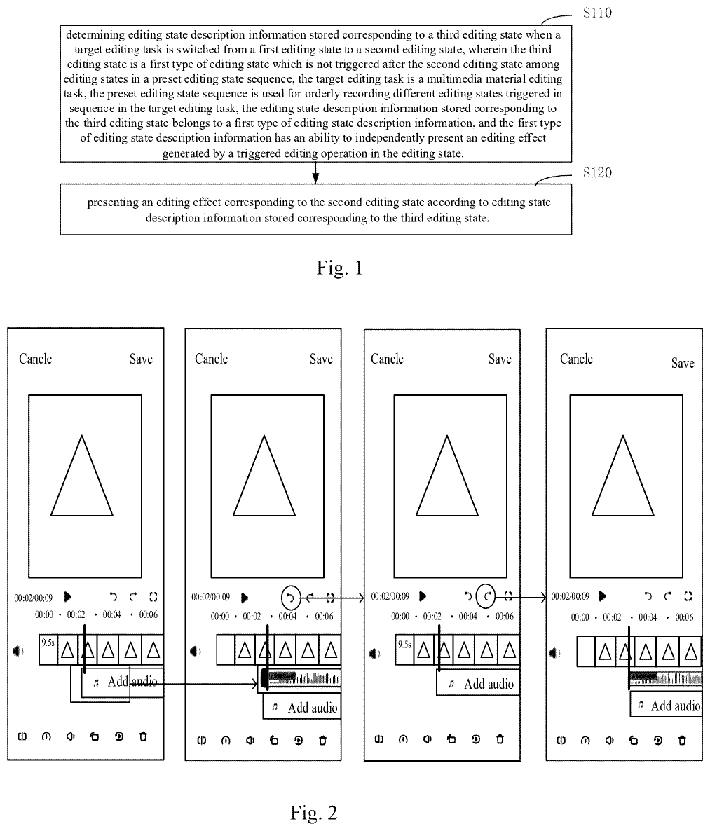

FIG. 1 is a flowchart of a multimedia material editing and processing method according to an embodiment of the present disclosure. The embodiment of the present disclosure is suitable for switching between different editing states to display editing results in a process of editing multimedia materials. The multimedia material editing and processing method can be executed by a multimedia material editing and processing apparatus. The multimedia material editing and processing apparatus can be implemented in a form of software and/or hardware, and is generally integrated on any electronic device with a network communication function, which may be a mobile terminal, a PC or a server.

As shown in FIG. 1, the multimedia material editing and processing method of the embodiment of the present disclosure may include the following steps:

S110: determining editing state description information that is stored corresponding to a third editing state when a target editing task is switched from a first editing state to a second editing state, wherein the third editing state is a first type of editing state that is not triggered after the second editing state among editing states in a preset editing state sequence, the target editing task is a multimedia material editing task, the preset editing state sequence is used for orderly recording different editing states triggered in sequence in the target editing task, the editing state description information that is stored corresponding to the third editing state belongs to a first type of editing state description information, and the first type of editing state description information has an ability to independently present an editing effect generated by a triggered editing operation in the editing state.

There is at least one reference editing state in the preset editing state sequence, editing state description information that is stored corresponding to the reference editing state belongs to a second type of editing state description information, and the second type of editing state description information is used for indicating an editing state difference between a second type of editing state and an adjacent editing state triggered before the second type of editing state in the preset editing state sequence.

The first type of editing state in the preset editing state sequence correspondingly stores the first type of editing state description information, the second type of editing state in the preset editing state sequence correspondingly stores the second type of editing state description information, the first type of editing state description information has an ability to independently present an editing effect generated by a triggered editing operation in the editing state, and the second type of editing state description information is used for indicating the editing state difference between the second type of editing state and the adjacent editing state triggered before the second type of editing state in the preset editing state sequence.

Referring to FIG. 2, in a multimedia material editing process, functionalities such as undoing a last editing operation and redoing a last undoing operation may be involved. For example, an editing operation of adding an audio may be performed in an editing page of a multimedia material corresponding to a target editing task, and after the editing operation of adding the audio is performed, it is supported to undo the last editing operation of adding the audio (such as undoing the added music, etc.) and redoing a last undone editing operation of adding the audio (such as redoing the added music, etc.).

Referring to FIG. 2, the editing state stored corresponding to the execution of one or more editing operations in a target editing page corresponding to the target editing task may be regarded as an edition version of the target editing page in a process of executing the editing operations, so that it is considered that the edition version of the target editing page corresponding to the target editing task has changed every time the editing operation is performed in the target editing page. For example, the undoing of the last editing operation can be considered as the degradation of the edition version of the target editing page, and the redoing of the last undoing can be considered as the upgrade of the edition version of the target editing page.

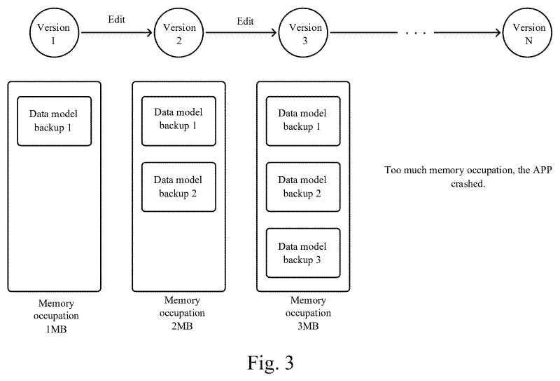

Referring to FIG. 2, the target editing page corresponding to the target editing task is likely to involve multiple editing operations, so that the target editing page corresponding to the target editing task will experience multiple editing states in an actual scenario, not just a simple editing state. Referring to FIG. 3, in order to achieve switching between different editing states, a data backup will be made for an editing result of the corresponding editing state after each editing operation, and then the editing result of the corresponding editing state can be accurately restored according to the data backup of any editing state. However, such operations will generate excessive data backups as the number of editing states increases, which will lead to a large number of redundant memory occupation, resulting in a sudden increase in the memory occupation required in the multimedia material editing process; especially when there are many editing operations on the multimedia materials, the memory occupation will increase linearly, and even lead to crashes due to excessive memory.

Based on the above situation, the preset editing state sequence is configured for the target editing task, and different editing states of the target editing task generated by triggering different editing operations in sequence in the target editing task can be recorded in an orderly manner by the preset editing state sequence. For example, the target editing task is in an editing state when no editing operation is performed, and is in another editing state after a video clip is added, and at least a part of the editing states is correspondingly stored with editing state description information, so as to present the editing result to be presented in the editing state according to the editing state description information. The editing state description information can be used to describe various parameters and features related to the editing state, such as special effects applied by the target editing task in the editing state, positions and durations of materials, and the like, and can be used to present an editing result correspondingly adapted to the target editing task in the editing state.

Meanwhile, considering that a large amount of data backups are brought along with the continuous increase of the editing states, resulting in a large amount of redundant memory occupation is caused, a preset editing state sequence in the solution records the first type of editing state and the second type of editing state, and the first type of editing state correspondingly stores the first type of editing state description information. The first type of editing state description information has an ability to independently present an editing effect generated by a triggered editing operation in the editing state, that is to say, the first type of editing state description information can support independent presentation of an editing effect generated by a triggered editing operation in its editing state, without the need for editing state description information that is stored corresponding to other editing states. This means that when it is necessary to display the editing result of the target editing task in the third editing state, the corresponding editing result can be completely presented by directly using the first type of editing state description information that is stored corresponding to the third editing state.

Correspondingly, different from the first type of editing state description information, the second type of editing state correspondingly stores the second type of editing state description information, and the second type of editing state description information is used for indicating an editing state difference between a second type of editing state and an adjacent editing state triggered before the second type of editing state in the preset editing state sequence, that is to say, the second type of editing state description information needs an editing state difference with respect to the adjacent editing state, thus the second type of editing state description information must rely on the editing state description information that is stored corresponding to other editing states to present the editing result of the target editing task. However, since the difference between the editing states is stored, the amount of memory occupied when storing the second type of editing state description information is less than that of the full storage, and this usually does not cause a sudden increase in the memory occupation required in the multimedia material editing process.

If there is no editing state description information of other editing states as support, the editing result of the target editing task to be presented in the first type of editing state can not be fully displayed only by relying on the second type of editing state description information. It can be understood that this dependency makes it necessary to consider whether the editing state description information of other editing states on which the second type of editing state description information depends is available and correct when processing the second type of editing state description information.

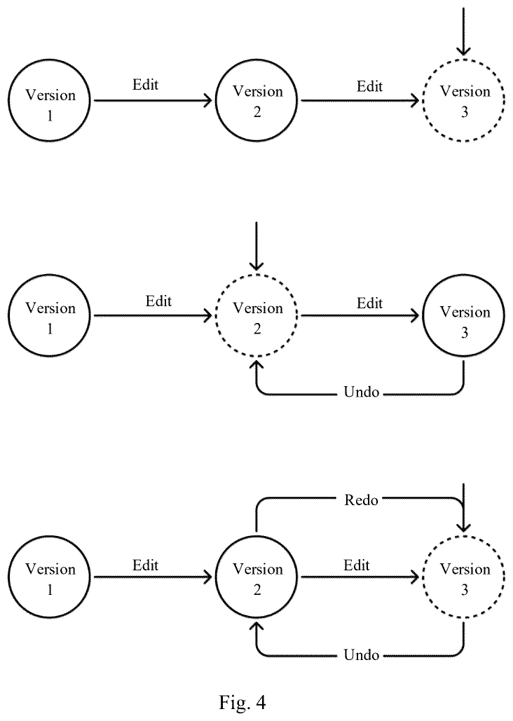

Referring to FIG. 2 and FIG. 4, when the switching from the first editing state to the second editing state is performed for the target editing task, it is actually intended to present the editing result of the target editing task in the second editing state. At this time, since not all editing states have the ability to independently present the editing effect generated by the triggered editing operation in the editing state, it is necessary to search for one first type of editing state from the preset editing state sequence, which has the ability to independently present the editing effect generated by the triggered editing operation in the editing state, in order to continuously iteratively restore the editing effect of the second editing state by using the editing state difference indicated by the second type of editing state description information on the basis of the first type of editing state. For example, it is found that the third editing state is the first type of editing state that is not triggered after the second editing state among the editing states in the preset editing state sequence.

By adopting the above mode, the editing result in a specific editing state can be accurately presented during the switching of editing states by using the ability of independently presenting the editing effect of the first type of editing state description information, so that it is convenient to continuously calculate editing effects of subsequent editing states starting from the first type of editing state. Meanwhile, the second type of editing state is introduced, and by storing the difference information with the adjacent editing state instead of complete description information of each editing state, the amount of stored data can be effectively reduced and the memory occupation space can be saved, so as to avoid the sudden increase of memory occupation and even crashes due to a large number of editing states in the multimedia material editing process.

Optionally, the preset editing state sequence can be similar to a timeline or a state record list, which can clearly reflect the editing states presented after the target editing task has undergone various editing operations from the beginning to the current in sequence. Optionally, the target editing task is a multimedia material editing task, and the multimedia material editing task may process and modify the multimedia material to achieve an editing task with an expected editing effect. Multimedia materials may refer to various original materials used to compose multimedia works, and the multimedia materials may include at least one of video materials, audio materials, image materials, etc. For example, editing tasks such as editing, adding effects, and making subtitles are performed on multimedia content such as videos, audios, and images.

As an optional but non-limiting implementation, switching from the first editing state to the second editing state is a switching triggered by performing an undoing operation on a reference change operation or a switching triggered by performing a redoing operation on the reference change operation after undoing the reference change operation, and the reference change operation is an operation of changing an editing result by performing an editing operation on a multimedia material in a multimedia material editing process.

The multimedia material editing task usually involves the processing and modification of images, videos, audios and other types of materials. The multimedia material editing process can include various editing operations such as cropping, adjusting colors, adding special effects, splicing and mixing, each editing operation after completed can correspond to one editing state, and each editing state will correspond to a version of editing state description information. For example, in video material editing, a video material may be edited, and subjected to addition of a transition effect, and brightness and contrast adjustment, and each editing operation after completed may correspond to a version of editing state description information.

Referring to FIG. 4, the editing state may refer to an editing state achieved after a series of editing operations are carried out in a process of executing the multimedia material editing task, and this editing state is characterized by specific multimedia material combination, special effect application, a duration and other editing operations after the multimedia material is edited. For example, in video material editing, the editing state may be a state where specific filters, subtitles and music have been added and a video material has been clipped and spliced to some extent.

Referring to FIG. 4, the reference change operation is a change operation for performing an editing operation on the multimedia material corresponding to the target editing task so that the editing result is gradually changed with respect to a state in which the multimedia material is edited in the target editing task. When the undoing operation is detected for a reference change operation, switching from the first editing state to the second editing state is triggered; or, when the reference change operation is undone and then redone, switching from the first editing state to the second editing state is triggered.

Optionally, referring to FIG. 4, as for undoing the reference change operation, when the reference change operation is undone in the multimedia material editing process, the switching from the current editing state to another editing state is triggered, and the undoing operation means canceling the editing operation corresponding to the previously executed reference change operation. As for undoing the reference change operation and then redoing the reference change operation, undoing the reference change operation will return the multimedia material to the editing state before the operation is undone, and then this undone reference change operation is redone.

Exemplarily, referring to FIG. 4, it is assumed that the editing state of version 2 where the target editing task is located corresponds to an original video material without any special effects and clips added, a specific filter and a piece of music are added to the video material in the multimedia material editing process, which, at this time, is equivalent to performing a reference change operation, thereby changing and adjusting the video material to the editing state of version 3 with the specific filter and the piece of music added. Previously, the reference change operation has been performed once, undoing this reference change operation will restore the video material to the editing state before the change and adjustment, and at this time, the target editing task is adjusted from the editing state of version 3 to the editing state of version 2. Then, after the reference change operation is undone, the reference change operation is redone, and the target editing task is adjusted from the editing state of version 2 to the editing state of version 3.

Optionally, the reference change operation may include editing operations such as clipping a multimedia material segment, adding a transition effect and adjusting colors for the target editing task. The reference change operation may include editing operations such as adjusting a volume, adding a sound effect and mixing for the target editing task. The reference change operation may include editing operations such as adding subtitles, adjusting a playback speed, and cropping video screen. A scenario where the reference change operation occurs is when editing the multimedia material, including but not limited to processing various types of multimedia materials such as images, videos and audios. The reference change operation is an editing operation that performs various editing actions on the multimedia material in the target editing task to change the editing result.

As for the switching from the first editing state to the second editing state for the target editing task, great editing flexibility is provided, the required editing operation can be undone at any time as needed, so as to return to the previous editing state, or can be redone as desired after undoing, thus achieving accurate control of the editing process. Moreover, the above switching makes it possible to quickly switch between different states, thus improving the editing efficiency. If a wrong editing operation is accidentally carried out, an error can be easily corrected through an undoing and redoing mechanism, and the influence of the wrong operation on the whole editing task can be reduced, so that different editing possibilities can be explored more freely without worrying about serious consequences caused by the wrong operation.

S120: presenting an editing effect corresponding to the second editing state according to editing state description information that is stored corresponding to the third editing state.

As for the third editing state that meets the condition and is found in the preset editing state sequence, the third editing state is the first type of editing state that is not triggered after the second editing state among the editing states in the preset editing state sequence, that is to say, those editing states that are not later than the second editing state in an editing order and belong to the first type of editing state are selected from all editing states included in the preset editing state sequence.

After the third editing state is determined, the editing state description information that is stored corresponding to the third editing state may be obtained. The editing state description information that is stored corresponding to the third editing state belongs to the first type of editing state, thus the editing state description information that is stored corresponding to the third editing state has the ability to independently present the editing effect generated by the triggered editing operation in the third editing state.

Based on the editing state description information of the third editing state, the editing state difference indicated by the editing state description information of the second type of editing state is continuously used for iterative recovery, so as to present the editing effect corresponding to the second editing state of the target editing task. The above may involve appropriately converting or mapping the editing state description information of the third editing state, or combining the editing state description information of the third editing state with editing state description information that is stored corresponding to respective editing states involved from the third editing state to the second editing state to control the presentation of the editing result of the target editing task in the second editing state.

By using the description information of the third editing state to present the editing effect of the second editing state, multimedia content in a specific editing state can be restored more accurately. Because the first type of editing state description information has the ability to independently present the editing effect, it can provide a reliable basis for the presentation of the second editing state. And, through efficient editing state switching and backtracking, it is more efficient to switch and backtrack between different editing states. When switching from one editing state to another, it is not necessary to reload all multimedia materials and re-execute all editing operations, only presentation is required based on existing editing state description information, and for some editing states, only the second type of editing state description information needs to be stored instead of complete editing state description information, so that the amount of stored data can be significantly reduced.

As an optional but non-limiting implementation, when the third editing state is the second editing state and belongs to the first type of editing state, the presenting an editing effect corresponding to the second editing state according to editing state description information that is stored corresponding to the third editing state includes the following steps:
directly loading the editing state description information that is stored corresponding to the third editing state, and generating and presenting an editing page including the editing effect corresponding to the second editing state.

When the third editing state is the second editing state and belongs to the first type of editing state, it means that the switched second editing state and the selected third editing state are actually the same editing state, but they are described from different angles. Since the third editing state and the second editing state are the same state, the editing state description information that is stored corresponding to the third editing state directly corresponds to the editing state description information that is stored corresponding to the second editing state; and since the third editing state is the first type of editing state, the editing state description information that is stored corresponding to the third editing state can be directly loaded. Therefore, the editing effect generated by the triggered editing operation in the editing state can be independently presented without relying on the editing state description information that is stored corresponding to other editing states.

According to the editing state description information that is stored corresponding to the loaded third editing state, an editing page with the corresponding editing effect when the target editing page is in the second editing state is generated. This process involves transforming the editing description information into an actual multimedia clip presentation form. Optionally, the editing state description information that is stored corresponding to the third editing state selected for the target editing task is read, and the editing state description information that is stored corresponding to the third editing state is loaded to present the editing page corresponding to the third editing state, wherein the editing page is configured with an editing track for carrying multimedia clips generated by the editing operation triggered for the multimedia material in the target editing task.

For example, if the editing state description information that is stored corresponding to the third editing state contains a specific video effect, when an editing page is generated, the special effect which corresponds to the editing state description information that is stored corresponding to the third editing state will be applied to the corresponding video clip and displayed in the editing page. Meanwhile, other multimedia elements of the multimedia material corresponding to the target editing task, such as audio tracks and subtitles, will be laid out according to the editing state description information that is stored corresponding to the third editing state, so as to present the complete editing effect of the target editing task in the third editing state.

According to the technical solution of the embodiment of the present disclosure, at least one editing state of the second type is set in the preset editing state sequence, and the editing state description information that is stored corresponding to the second type of editing state is used for indicating a difference between the editing state and a previous adjacent editing state, so that the amount of data backup storage for each editing state can be effectively reduced due to the fact that only the description information difference between the editing states needs to be stored, instead of the complete description information of each editing state. In this way, when switching from the first editing state to the second editing state, the editing state description information that is stored corresponding to the third editing state is determined first, the third editing state is the first type of editing state that is not triggered after the second editing state in the preset editing state sequence, and the first type of editing state description information has the ability to independently present the corresponding editing effect. Furthermore, in combination with the editing state description information that is stored corresponding to at least one editing state of the second type in the preset editing state sequence, the editing result corresponding to the second editing state can be quickly calculated and updated, thereby enabling not only rapid switching between editing states, but also rapid restoration of the previous editing state for modification. Meanwhile, when storing the data backup corresponding to the editing state, the second type of editing state is introduced, and by storing the difference information with the adjacent editing state instead of the complete description information of each editing state, it is not necessary to store the data backup of each editing state in full, but only the difference amount of description information between editing states needs to be stored, so that a large amount of redundant memory occupation is reduced and the problem of crashes caused by a sudden increase or even excessive memory occupation in the multimedia material editing process is avoided as much as possible.

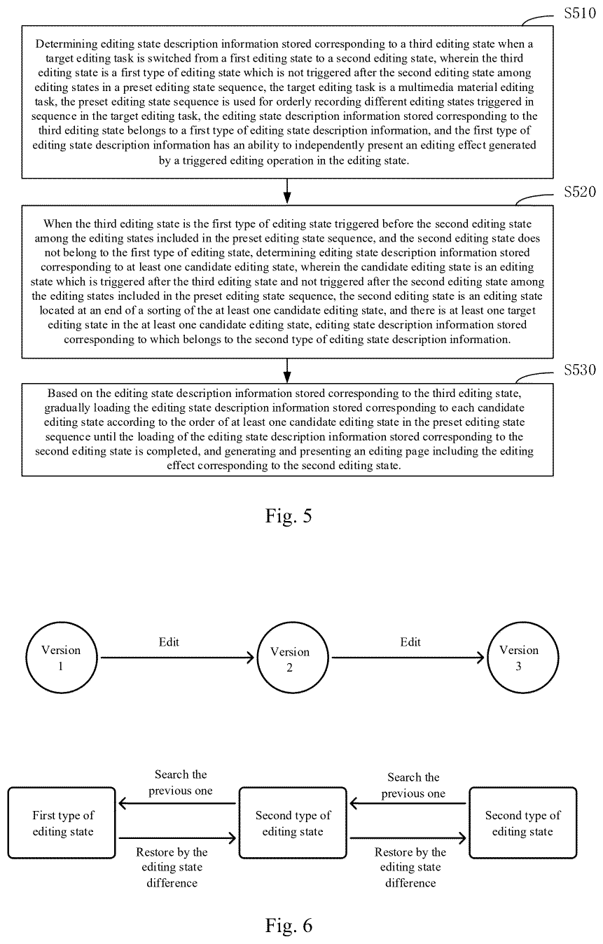

FIG. 5 is a flowchart of another multimedia material editing processing method according to an embodiment of the present disclosure. Based on the technical solution of the above embodiment, the technical solution of this embodiment further optimizes the process of presenting the editing effect corresponding to the second editing state according to the editing state description information that is stored corresponding to the third editing state in the above embodiments, and this embodiment can be combined with various alternatives in one or more of the above embodiments.

As shown in FIG. 5, the multimedia material editing and processing method of the embodiment of the present disclosure may include the following steps:

S510: determining editing state description information that is stored corresponding to a third editing state when a target editing task is switched from a first editing state to a second editing state, wherein the third editing state is a first type of editing state that is not triggered after the second editing state among editing states in a preset editing state sequence, the target editing task is a multimedia material editing task, the preset editing state sequence is used for orderly recording different editing states triggered in sequence in the target editing task, the editing state description information that is stored corresponding to the third editing state belongs to a first type of editing state description information, and the first type of editing state description information has an ability to independently present an editing effect generated by a triggered editing operation in the editing state.

There is at least one reference editing state in the preset editing state sequence, editing state description information that is stored corresponding to the reference editing state belongs to a second type of editing state description information, and the second type of editing state description information is used for indicating an editing state difference between a second type of editing state and an adjacent editing state triggered before the second type of editing state in the preset editing state sequence.

As an optional but non-limiting implementation, the determining editing state description information that is stored corresponding to a third editing state includes the following steps A1-A2:
Step A1: searching the third editing state from editing states included in the preset editing state sequence according to an order of the editing states in the preset editing state sequence.
Step A2: obtaining the editing state description information that is stored corresponding to the third editing state from the editing state description information that is stored corresponding to the editing states in the preset editing state sequence.

Referring to FIG. 6, the preset editing state sequence is a collection of orderly records of different editing states triggered in sequence in the target editing task, and each editing state has a specific position and order in the preset editing state sequence. In order to search the third editing state that meets the requirements, each editing state in the preset editing state sequence can be traversed in a reverse direction from the second editing state according to the order of the editing states in the preset editing state sequence; for example, starting from the second editing state, each editing state in the preset editing state sequence is tracked back and traversed backwards. Since the third editing state is the first type of editing state that is not triggered after the second editing state among all editing states in the preset editing state sequence, it is necessary to judge whether each editing state meets this condition one by one in a searching process. If there are one or more editing states in the preset editing state sequence which are not triggered after the second editing state and belong to the first type of editing state, then this editing state is determined as the third editing state.

Referring to FIG. 6, after the third editing state is determined, the editing state description information that is stored corresponding to the third editing state can be obtained from the editing state description information that is stored corresponding to respective editing states in the preset editing state sequence. The editing state description information is usually a data structure associated with the editing effect corresponding to the target editing task in each editing state. For example, for a video editing task, the editing state description information may include a position, a length, a special effect, a transition effect, etc. of a video clip; and for an image editing task, the description information may include color adjustment, a filter effect, a cropping size, etc. Optionally, through an index or identification of a version number corresponding to the third editing state, the editing state description information that is stored corresponding to the third editing state can be quickly located and extracted for subsequent processing and presentation.

By adopting the above mode, the third editing state that meets the condition can be found accurately by searching according to the order of the editing states. This method avoids random searching or an uncertain searching mode, and improves the accuracy and reliability of searching, and the orderly searching can search the appropriate first type of editing state nearby, avoiding generating a longer iterative recovery link when iterative recovery is performed by using the difference. Meanwhile, the orderly searching can make use of structural characteristics of the preset editing state sequence to improve the search efficiency. And, it can adapt to different types of editing tasks and changes in the editing states. Whether it is simple text editing or complex multimedia editing, the editing state can be effectively managed and searched in this way.

As an optional but non-limiting implementation, a preset number of the second type of editing states are configured between two closest first type of editing states in the preset editing state sequence, a value of the preset number is determined based on a size of memory resources allocated for multimedia editing tasks, and the size of the memory resources allocated for the multimedia editing tasks is negatively correlated with the value of the preset number.

Referring to FIG. 6, in the preset editing state sequence, a first type of editing state and a second type of editing state are distinguished according to the facts that the first type of editing state usually has the ability to independently present the editing effect, while the second type of editing state stores editing state difference information with the adjacent editing state. A preset number of the second type of editing states is configured between two closest first type of editing states, and this preset number is determined according to a size of memory resources allocated for the multimedia editing task.

If the size of the allocated memory resources is small, a relatively large preset number can be set, so as to store more intermediate state difference information between two first type of editing states, improve the fineness and traceability of editing states, and reduce the memory occupation during data storage as much as possible. On the contrary, if the size of the memory resources is relatively large, it is necessary to set a smaller preset number and use the first type of editing state description information as much as possible, so there is no need to worry about excessive memory occupation. The size of memory resources allocated for multimedia editing tasks is negatively correlated with the value of the preset number, which means that when the memory resources are sufficient, the preset number of the second type of editing state description information can be appropriately reduced, so as to better record the first type of editing state in the editing process and facilitate rapid restoration to the subsequent editing state.

By adopting the above technical solution, the number of the second type of editing states can be flexibly adjusted according to the size of memory resources allocated for multimedia editing tasks, so that available memory resources can be utilized to the maximum extent under different hardware environments and task requirements, and the adaptability of the system can be improved. By reasonably configuring the number of the second type of editing states, the memory occupation can be minimized on the premise of ensuring an editing function. Only necessary intermediate state difference information is stored, which avoids storing a large amount of complete data of the editing states, thus improving the efficiency of memory usage.

S520: when the third editing state is the first type of editing state triggered before the second editing state among the editing states included in the preset editing state sequence, and the second editing state does not belong to the first type of editing state, determining editing state description information that is stored corresponding to at least one candidate editing state, wherein the candidate editing state is an editing state that is triggered after the third editing state and not triggered after the second editing state among the editing states included in the preset editing state sequence, the second editing state is an editing state located at an end of a sorting of the at least one candidate editing state, and there is at least one target editing state in the at least one candidate editing state, editing state description information that is stored corresponding to which belongs to the second type of editing state description information.

Among the at least one candidate editing state, at least one target editing state belongs to the second type of editing state, and the editing state description information that is stored corresponding to the target editing state is used for indicating an editing state difference between the target editing state and an editing state that is triggered before the target editing state and adjacent to the target editing state in the preset editing state sequence.

Referring to FIG. 6, the third editing state is the first type of editing state that is triggered before the second editing state among the editing states included in the preset editing state sequence, which means that searching is performed among the editing states in the preset editing state sequence which are located before the editing sequence corresponding to the second editing state, and the third editing state that meets the condition is found. The first type of editing state can usually independently present the editing effect generated by the triggered editing operation in the editing state, and the third editing state that meets this condition can be determined by traversing and filtering the preset editing state sequence.

Referring to FIG. 6, since the third editing state and the second editing state in the preset editing state sequence are not the same editing state, and the third editing state is located before the second editing state, it is necessary to find out editing states from the third editing state to the second editing state as candidate editing states. That is, the candidate editing state is an editing state that is triggered after the third editing state and not triggered after the second editing state among the editing states included in the preset editing state sequence.

Referring to FIG. 6, in the preset editing state sequence, each editing state is searched backwards in turn from the third editing state, and it is judged whether the editing state meets the condition that the editing state is triggered after the third editing state and not after the second editing state, and the editing state meeting this condition is determined as a candidate editing state. It is known that the second editing state does not belong to the first type of editing state, and the second editing state is an editing state located at an end of a sorting of the at least one candidate editing state searched above, which indicates that the second editing state is the last one in a series of specific editing states.

Referring to FIG. 6, among the candidate editing states, at least one target editing state belongs to the second type of editing state, and the editing state description information that is stored corresponding to the target editing state is used for indicating editing state difference between the target editing state and an editing state that is triggered before the target editing state and adjacent to the target editing state in the preset editing state sequence. This means that for the second type of target editing state, its stored information is the difference relative to the previous adjacent state. On the basis that the third editing state and the candidate editing state are determined, the editing effect of the second editing state can be inferred or restored by using the information of the third editing state and the editing state difference of the target editing state in the candidate editing state.

By adopting the above mode, by clarifying definitions of and relationships between different types of editing states, accurate management of the editing states can be realized, and positions and properties of specific editing states in the whole sequence can be accurately determined, thus providing a reliable basis for subsequent editing operations and state switching. For the second type of editing state, the amount of stored data can be greatly reduced by storing the difference between the editing state and the previous adjacent state. And, switching and backtracking between different editing states can be performed as needed, and rapid recovery and adjustment of the state can be performed by using the difference.

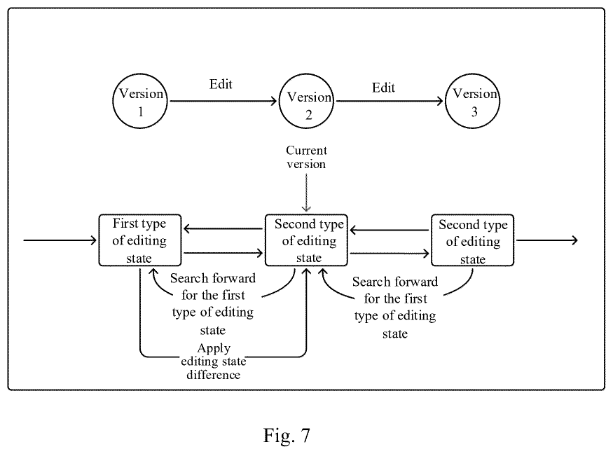

Referring to FIG. 6 and FIG. 7, the second type of editing state description information exhibits an extremely significant advantage in memory occupation, and its memory occupation is much smaller than that of the first type of editing state description information. The reason why such a difference occurs is mainly because, in the second type of editing state description information, instead of storing complete data of the editing states as in the first type, only editing state difference information between two adjacent editing states in the preset editing state sequence is stored. Due to this storage mode, even if the number of editing states gradually increases during continuous editing operations, the total memory usage of the editing state description information will not increase rapidly. Especially for those application scenarios that need to process a large amount of editing state description information, this is undoubtedly a crucial advantage. It can effectively control the consumption of memory resources while ensuring normal realization of the editing function, and avoid system performance degradation or instability caused by excessive memory occupation.

With continued reference to FIG. 6 and FIG. 7, when the editing state correspondingly stores the first type of editing state description information, the first type of editing state description information is directly loaded for recovery. This is because the first type of editing state description information has the ability to independently present the editing effect generated by the triggered editing operation in the editing state. However, when the editing state correspondingly stores the second type of editing state description information, the situation is different; considering that only the first type of editing state description information has the ability to independently present the editing effect generated by the triggered editing operation in the editing state, relying solely on the second type of editing state description information is not sufficient to restore the editing state. In this case, it is necessary to backtrack from the second editing state in the preset editing state sequence according to the order of the editing states, and then search for one first type of editing state closest to the second editing state one by one as the third editing state. Since the third editing state belongs to the first type of editing state, the editing state description information that is stored corresponding to the third editing state can be used as the basis for restoring the target editing task to the second editing state. In this way, when faced with different types of editing state description information, the restoration operation of the editing state can be effectively realized, and the smooth progress of the editing task can be ensured.

S530: based on the editing state description information that is stored corresponding to the third editing state, gradually loading the editing state description information that is stored corresponding to each candidate editing state according to the order of at least one candidate editing state in the preset editing state sequence until the loading of the editing state description information that is stored corresponding to the second editing state is completed, and generating and presenting an editing page including the editing effect corresponding to the second editing state.

Referring to FIG. 6 and FIG. 7, after the editing state description information that is stored corresponding to the third editing state is determined, the operation is performed according to the order of candidate editing states in the preset editing state sequence. Firstly, starting from the first candidate editing state, the editing state description information that is stored corresponding to each candidate editing state is loaded gradually. In this loading process, the editing state is continuously updated and accumulated based on the previous editing state combined with the description information of each candidate editing state. For example, when there is a specific video effect in the third editing state and a subtitle is added in the first candidate editing state, subtitle information will be added to the existing effect when the description information of the first candidate editing state is loaded. Then, the process of continuously superimposing the editing state description information that is stored corresponding to the candidate editing state is continued, in which subsequent description information of the candidate editing state is sequentially loaded on the basis of the previous editing state until the loading of the editing state description information corresponding to the second editing state is completed. When the editing state description information of the second editing state is successfully loaded, an editing page containing the editing effect corresponding to the second editing state is generated by using the information. This editing page will be displayed on a specific editing software interface, and users can clearly see complete editing effects of multimedia content in the second editing state, including image adjustment, video effects and subtitles, audio processing and so on.

Referring to FIG. 6 and FIG. 7, taking the editing state description information that is stored corresponding to the third editing state as a starting point, the editing state description information that is stored corresponding to each candidate editing state is gradually applied backwards from this point in the preset editing state sequence. Specifically, according to the order of the candidate editing states in the preset editing state sequence, the editing state difference indicated in the editing state description information that is stored corresponding to each candidate editing state is loaded to the previous editing state of the target editing task in turn until the second editing state that is finally to be restored by loading the editing state description information that is stored corresponding to the second editing state. In this way, the switching operation from the first editing state to the second editing state can be implemented by using the second type of editing state description information. At the same time, this method can effectively control the memory occupation and greatly improve the performance and stability of the system. It not only ensures smooth switching of the editing states, but also avoids situations of system performance degradation or instability caused by high memory occupation, thus providing users with a smoother and more efficient editing experience.

By adopting the above mode, the description information of the candidate editing states is loaded gradually based on the description information of the third editing state, so that the editing effect of the second editing state can be accurately restored. This mode ensures that no important editing information will be lost in the process of switching or restoring the editing state, and the editing page completely consistent with that of the previous departure can be seen. Moreover, this implementation makes it more efficient to switch and backtrack between different editing states, and it is not necessary to reload all multimedia materials and re-execute all editing operations, but to quickly restore to the target editing state by gradually loading description information. It is worth mentioning that the amount of data loaded can be reduced since the editing state description information is loaded gradually, instead of loading all the state data at one time. Especially when processing large multimedia materials, a response speed of the system can be significantly increased, long-term waiting can be avoided, the editing effects in different editing states can be quickly and accurately seen, and the user can more conveniently carry out editing operations and try different editing schemes without worrying about the complexity and time consumption of state switching.

As an optional but non-limiting implementation, when the third editing state is the first type of editing state that is triggered before the second editing state and is closest to the second editing state among editing states included in the preset editing state sequence and the second editing state does not belong to the first type of editing state, the at least one candidate editing state belongs to the second type of editing state.

The third editing state is the first type of editing state that is triggered before the second editing state and closest to the second editing state, which means that it is necessary to traverse the entire editing state sequence and make a judgement for each editing state. When an editing state belongs to the first type, and it is ahead of the second editing state in a time sequence, and it is closer to the second editing state than other first type of editing states which are ahead of the second editing state, then this state is determined as the third editing state.

When a relationship between the third editing state and the second editing state is determined, a property of at least one candidate editing state is further clarified. In this case, it is stipulated that the at least one candidate editing state each belongs to the second type of editing state, which means that these candidate editing states can take advantage of specific attributes and advantages of the first type of editing state in the subsequent processing. For example, the first type of editing state may have the ability to independently present the editing effect, which is very important for restoring and processing the editing state.

When it is necessary to switch from the first editing state to the second editing state or perform other related operations properties of the third editing state and the candidate editing state are first determined, and the restoration operation is gradually carried out based on the third editing state and in combination with the information of the candidate editing state. Since the candidate editing states all belong to the second type of editing states, it is only necessary to sequentially superimpose and accumulate the second type of editing state description information that is stored corresponding to each candidate editing state starting from the editing state description information that is stored corresponding to the third editing state, so as to restore the editing result of the second editing state.

By adopting the above mode, by determining that the third editing state is the first type of editing state closest to the second editing state, the state switching and the restoration operation can be performed more accurately, especially in complex editing tasks, the restoration to the closest first type of editing state can be ensured, and unnecessary loading processing of other editing state description information of the first type is reduced, so that the efficiency and accuracy are improved, a data processing amount and calculation time can be reduced, and a performance and a response speed of the system can be improved.

According to the technical solution of the embodiment of the present disclosure, at least one second type of editing state is set in the preset editing state sequence, and the editing state description information that is stored corresponding to the second type of editing state is used for indicating a difference between the editing state and a previous adjacent editing state, so that the data backup storage amount of each editing state can be effectively reduced due to the fact that only the description information difference between the editing states needs to be stored, instead of the complete description information of each editing state. In this way, when switching from the first editing state to the second editing state, the editing state description information that is stored corresponding to the third editing state is determined first, the third editing state is the first type of editing state that is not triggered after the second editing state in the preset editing state sequence, and the first type of editing state description information has the ability to independently present the corresponding editing effect. Furthermore, in combination with the editing state description information that is stored corresponding to at least one second type of editing state in the preset editing state sequence, the editing result corresponding to the second editing state can be quickly calculated and updated, thereby enabling not only rapid switching between editing states, but also rapid restoration of the previous editing state for modification. Meanwhile, when storing the data backup corresponding to the editing state, it is not necessary to store the data backup of each editing state in full, but only the difference amount of description information between editing states needs to be stored, so that a large amount of redundant memory occupation is reduced and the problem of crashes caused by a sudden increase or even excessive memory occupation in the multimedia material editing process is avoided as much as possible.

On the basis of the above embodiment, optionally, before the determining editing state description information that is stored corresponding to a third editing state, the method further includes the following steps C1-C3:
Step C1: determining first editing task information when the target editing task is in a fourth editing state, wherein the first editing task information is capable of supporting independent description of an editing result generated by a triggered editing operation for the target editing task in the fourth editing state, and the fourth editing state belongs to the first type of editing state in the preset editing state sequence.
Step C2: determining second editing task information when the target editing task is in a fifth editing state, wherein the second editing task information is capable of supporting independent description of an editing result generated by a triggered editing operation for the target editing task in the fifth editing state, and the fifth editing state is the second type of editing state, which is triggered after the editing operation is continuously triggered for the target editing task already in the fourth editing state and is adjacent to the fourth editing state.
Step C3: comparing the second editing task information with the first editing task information to determine editing state description information that is stored corresponding to the fifth editing state.

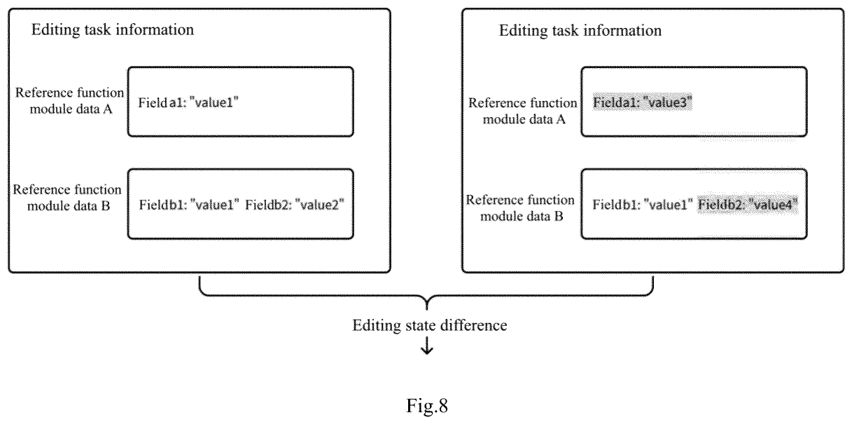

Referring to FIG. 8, when the target editing task is in the fourth editing state, it is necessary to determine the first editing task information that can independently describe the editing result generated by the triggered editing operation in this state. Because the fourth editing state belongs to the first type of editing state in the preset editing state sequence, the first type of editing state usually has the characteristic of independently presenting the editing effect. The first editing task information may include various parameters and features related to the presentation of the corresponding editing result of the target editing task in the fourth editing state, which may, for example, include color adjustment parameters, filter effects, cropping sizes, etc., and, in video editing, may include positions, lengths, special effect parameters and transition effects of video clips.

Referring to FIG. 8, when the target editing task is in the fifth editing state, the second editing task information that can independently describe the editing result generated by the triggered editing operation in this state is determined. The fifth editing state is the second type of editing state, which is triggered after the editing operation is continuously triggered the editing operation for the target editing task already in the fourth editing state, and is adjacent to the fourth editing state. Similarly, the second editing task information also contains various parameters and features related to the presentation of the corresponding editing result of the target editing task in the fifth editing state, and the second type of editing state correspondingly stores the second type of editing state description information.

Referring to FIG. 8, the second editing task information is compared with the first editing task information, and by comparing the difference between the two types of editing task information, the editing state description information that is stored corresponding to the fifth editing state can be determined. This process may involve comparing parameters one by one to find out which parameters have changed and the specific content of the changes. For example, when a new effect is added in the fifth editing state, relevant parameters of this effect will be recorded in the editing state description information. The finally determined editing state description information can be used for subsequent editing state switching, backtracking and other operations, as well as restoring to a specific editing state.

By adopting the above mode, the editing results in different editing states can be accurately and independently described by determining the first editing task information and the second editing task information respectively, so that a specific situation of the target editing task in a specific editing state can be clearly understood at any time; and the process of determining the editing state description information is based on the task information comparison of two adjacent editing states, so that the specific content of the state change can be quickly and accurately determined, and by accurately understanding the changes of the editing states, the user can switch to different editing states at any time for viewing and modification.

On the basis of the above-mentioned embodiment, optionally, with reference to FIG. 8, the comparing the second editing task information with the first editing task information to determine the editing state description information that is stored corresponding to the fifth editing state include steps D1-D2:
Step D1: traversing to obtain each item of reference function module data in the second editing task information and each item of reference function module data in the first editing task information and performing an item-by-item comparison, wherein the second editing task information and the first editing task information are configured to use the same type of reference function attribute field to describe the same item of reference function module data.
Step D2: determining the editing state description information that is stored corresponding to the fifth editing state based on an item-by-item comparison result of each item of reference function module data in the second editing task information and each item of reference function module data in the first editing task information.

Referring to FIG. 8, the second editing task information and the first editing task information are traversed, and respectively describe editing results of the target editing task in different editing states.

Reference function module data can be understood as data of function parts constituting the editing task. For example, in image editing, it may include color adjustment module data, filter module data, cropping module data, etc.; and in video editing, there may be video clip module data, effect module data, transition module data and so on. Each item of reference function module data is configured and described by using a reference function attribute field, wherein the reference function attribute field can be a field a1, a field b1, etc. shown in FIG. 8, and the reference function attribute field is used for describing an attribute field of an editing function adopted by the video material and the audio material.

And, the two types of editing task information are configured to describe the same reference function attribute field in the same reference function module data, which means that the description mode of the same function module in different editing states is consistent, differing only in resultant values. In a traversal process, each item of the reference function module data in the second editing task information is compared with the corresponding item in the first editing task information one by one. The content of comparison includes but is not limited to parameter values and state flags of the module.

When a certain item of the reference function module data is different in the two types of editing task information, this difference will be recorded and used as part of the editing state description information in the fifth editing state. For example, When an intensity value of a certain filter changes in the second editing task information, this change will be recorded and used for describing the change from the fourth editing state to the fifth editing state. Finally, by integrating the comparison results of all the reference function module data, the complete editing state description information that is stored corresponding to the fifth editing state is obtained.

By adopting the above mode, through item-by-item comparison of the reference function module data, changes between editing states can be detected very finely. This enables the system to accurately record and describe state changes brought about by each subtle editing operation, providing users with more precise editing state backtracking and switching functions. Because the same type of reference function attribute fields are used for description, the consistency and understandability of data are ensured. This makes it easier for developers to understand and process the editing state data when maintaining the system, and the maintainability of the system is improved. Meanwhile, errors and confusion that may be caused by inconsistent data descriptions can also reduced. Only recording the difference information between the editing states can greatly reduce the amount of stored data, which is very important for dealing with a large number of editing tasks and a long-term editing process, and can avoid storing excessive redundant data and improve the storage efficiency.

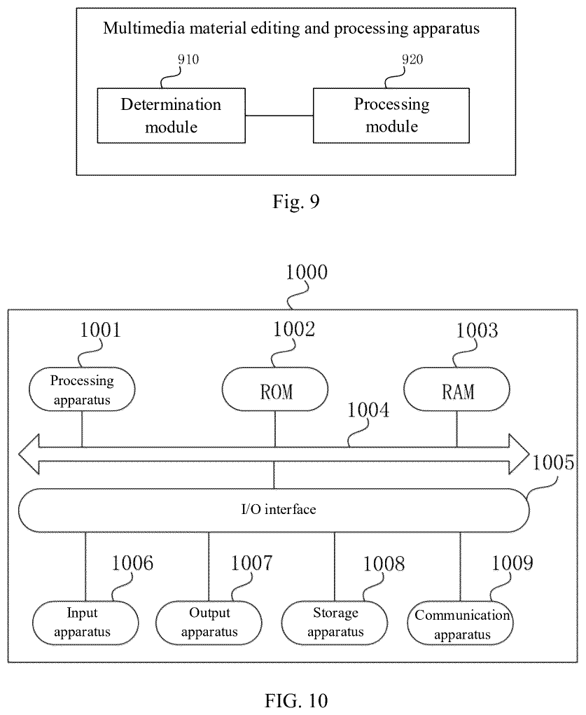

FIG. 9 is a structural schematic diagram of a multimedia material editing and processing apparatus according to an embodiment of the present disclosure. The embodiment of the present disclosure is suitable for a case that editing results are switched and displayed in different editing states in a process of editing multimedia materials. The multimedia material editing and processing apparatus can be implemented in the form of software and/or hardware, and is generally integrated on any electronic device with a network communication function, which can be a mobile terminal, a PC or a server.

As shown in FIG. 9, the multimedia material editing and processing apparatus of the embodiment of the present disclosure may include:
a determination module 910 configured to determine editing state description information that is stored corresponding to a third editing state when a target editing task is switched from a first editing state to a second editing state, wherein the third editing state is a first type of editing state that is not triggered after the second editing state among editing states in a preset editing state sequence, the target editing task is a multimedia material editing task, the preset editing state sequence is used for recording different editing states triggered in sequence in the target editing task in an orderly manner, editing state description information that is stored corresponding to the third editing state belongs to a first type of editing state description information, and the first type of editing state description information has an ability to independently present an editing effect generated by a triggered editing operation in the editing state; there is at least one reference editing state in the preset editing state sequence, editing state description information that is stored corresponding to the reference editing state belongs to a second type of editing state description information, and the second type of editing state description information is used for indicating an editing state difference between a second type of editing state and an adjacent editing state triggered before the second type of editing state in the preset editing state sequence; and
a processing module 920 configured to present an editing effect corresponding to the second editing state according to editing state description information that is stored corresponding to the third editing state.

On the basis of the above embodiment, optionally, switching from the first editing state to the second editing state is a switching triggered by performing an undoing operation on a reference change operation or a switching triggered by performing a redoing operation on the reference change operation after undoing the reference change operation, and the reference change operation is an operation of changing an editing result by performing an editing operation on a multimedia material in a multimedia material editing process.

On the basis of the above embodiment, optionally, the determining editing state description information that is stored corresponding to a third editing state includes:
searching the third editing state from the editing states included in the preset editing state sequence according to an order of the editing states in the preset editing state sequence; and
obtaining the editing state description information that is stored corresponding to the third editing state from the editing state description information that is stored corresponding to the editing states in the preset editing state sequence.

On the basis of the above embodiment, optionally, when the third editing state is the second editing state and belongs to the first type of editing state, the presenting an editing effect corresponding to the second editing state according to editing state description information that is stored corresponding to the third editing state includes:
directly loading the editing state description information that is stored corresponding to the third editing state, and generating and presenting an editing page including the editing effect corresponding to the second editing state.

On the basis of the above embodiment, optionally, when the third editing state is the first type of editing state triggered before the second editing state among the editing states included in the preset editing state sequence and the second editing state does not belong to the first type of editing state, the presenting an editing effect corresponding to the second editing state according to editing state description information that is stored corresponding to the third editing state includes:
determining editing state description information that is stored corresponding to at least one candidate editing state, wherein the candidate editing state is an editing state that is triggered after the third editing state and not triggered after the second editing state among the editing states included in the preset editing state sequence, the second editing state is an editing state located at an end of a sorting of the at least one candidate editing state, and there is at least one target editing state in the at least one candidate editing state, editing state description information that is stored corresponding to which belongs to the second type of editing state description information; and
based on the editing state description information that is stored corresponding to the third editing state, gradually loading the editing state description information that is stored corresponding to each candidate editing state according to an order of at least one candidate editing state in the preset editing state sequence until the loading of the editing state description information that is stored corresponding to the second editing state is completed, and generating and presenting an editing page including the editing effect corresponding to the second editing state.

On the basis of the above embodiment, optionally, when the third editing state is the first type of editing state that is triggered before the second editing state and is closest to the second editing state among the editing states included in the preset editing state sequence and the second editing state does not belong to the first type of editing state, the at least one candidate editing state belongs to the second type of editing state.

On the basis of the above embodiment, optionally, a preset number of the second type of editing states are configured between two closest first type of editing states in the preset editing state sequence, a value of the preset number is determined based on a size of memory resources allocated for multimedia editing tasks, and the size of the memory resources allocated for the multimedia editing tasks is negatively correlated with the value of the preset number.

On the basis of the above embodiment, optionally, before the determining editing state description information that is stored corresponding to a third editing state, the method further includes:
determining first editing task information when the target editing task is in a fourth editing state, wherein the first editing task information is capable of supporting independent description of an editing result generated by a triggered editing operation for the target editing task in the fourth editing state, and the fourth editing state belongs to the first type of editing state in the preset editing state sequence;
determining second editing task information when the target editing task is in a fifth editing state, wherein the second editing task information is capable of supporting independent description of an editing result generated by a triggered editing operation for the target editing task in the fifth editing state, and the fifth editing state is the second type of editing state, which is triggered after the editing operation is continuously triggered for the target editing task already in the fourth editing state and is adjacent to the fourth editing state; and
comparing the second editing task information with the first editing task information to determine editing state description information that is stored corresponding to the fifth editing state.

On the basis of the above embodiment, optionally, the comparing the second editing task information with the first editing task information to determine the editing state description information that is stored corresponding to the fifth editing state includes:
traversing to obtain each item of reference function module data in the second editing task information and each item of reference function module data in the first editing task information and performing an item-by-item comparison, wherein the second editing task information and the first editing task information are configured to use the same type of reference function attribute field to describe the same item of reference function module data; and
determining the editing state description information that is stored corresponding to the fifth editing state based on an item-by-item comparison result of each item of reference function module data in the second editing task information and each item of reference function module data in the first editing task information.

According to the technical solution of the embodiment of the present disclosure, the preset editing state sequence can record different editing states triggered in sequence in the target editing task in an orderly manner, which makes it convenient to perform editing state switching when performing editing operations on the target editing task. When the editing results in different editing states are switched, a data backup will be generated for the editing result corresponding to the editing state after each editing operation, so that the editing result of any editing state can be accurately restored according to the data backup of the editing state later. However, this causes a large amount of memory to be occupied by the data backup in the editing state. To this end, in this solution, at least one of the second type of editing state is set in the preset editing state sequence, and the editing state description information that is stored corresponding to the second type of editing state is used for indicating a difference between the editing state and a previous adjacent editing state, so that the data backup storage amount of each editing state can be effectively reduced due to the fact that only the description information difference between the editing states needs to be stored, instead of the complete description information of each editing state. In this way, when switching from the first editing state to the second editing state, the editing state description information that is stored corresponding to the third editing state is determined first, the third editing state is the first type of editing state that is not triggered after the second editing state in the preset editing state sequence, and the first type of editing state description information has the ability to independently present the corresponding editing effect. Furthermore, in combination with the editing state description information that is stored corresponding to at least one of the second type of editing state in the preset editing state sequence, the editing result corresponding to the second editing state can be quickly calculated and updated, thereby enabling not only rapid switching between editing states, but also rapid restoration of the previous editing state for modification. Meanwhile, when storing the data backup corresponding to the editing state, it is not necessary to store the data backup of each editing state in full, but only the difference in the description information between editing states needs to be stored, so that a large amount of redundant memory occupation is reduced and the problem of crashes caused by a sudden increase or even excessive memory occupation in the multimedia material editing process is avoided as much as possible.

The multimedia material editing and processing apparatus according to the embodiment of the present disclosure can execute the multimedia material editing and processing method provided by any of embodiments of the present disclosure, and has corresponding functional modules for executing the multimedia material editing and processing method and beneficial effects.

It is worth noting that the various units and modules included in the above-mentioned device are only divided according to functional logic, but are not limited to the above-mentioned division, as long as the corresponding functions can be achieved; in addition, the specific names of the functional units are only for the convenience of distinguishing each other, and are not used to limit the scope of the embodiments of the present disclosure.

FIG. 10 is a schematic structural diagram of an electronic device for implementing a multimedia material editing processing method according to an embodiment of the present disclosure. Referring to FIG. 10, FIG. 10 illustrates a schematic structural diagram of an electronic device (e.g., terminal device or server in FIG. 10) 1000 suitable for implementing the embodiments of the present disclosure. The electronic devices in embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 10 is merely an example, and should not pose any limitation to the functions and the range of use of the embodiments of the present disclosure.

As illustrated in FIG. 10, the electronic device 1000 may include a processing apparatus 1001 (e.g., a central processing unit, a graphics processing unit, etc.), which can perform various suitable actions and processing according to a program stored in a read-only memory (ROM) 1002 or a program loaded from a storage apparatus 1008 into a random-access memory (RAM) 1003. The RAM 1003 further stores various programs and data required for operations of the electronic device 1000. The processing apparatus 1001, the ROM 1002, and the RAM 1003 are interconnected by means of a bus 1004. An input/output (I/O) interface 1005 is also connected to the bus 1004.

Usually, the following apparatus may be connected to the I/O interface 1005: an input apparatus 1006 including, for example, a touch screen, a touch pad, a keyboard, a mouse, a camera, a microphone, an accelerometer, a gyroscope, or the like; an output apparatus 1007 including, for example, a liquid crystal display (LCD), a loudspeaker, a vibrator, or the like; a storage apparatus 1008 including, for example, a magnetic tape, a hard disk, or the like; and a communication apparatus 1009. The communication apparatus 1009 may allow the electronic device 1000 to be in wireless or wired communication with other devices to exchange data. While FIG. 10 illustrates the electronic device 1000 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 1009 and installed, or may be installed from the storage apparatus 1008, or may be installed from the ROM 1002. When the computer program is executed by the processing apparatus 1001, the above-mentioned functions defined in the methods of some embodiments of the present disclosure are performed.

Names of messages or information exchanged among multiple devices in the embodiment of the present disclosure are only used for illustrative purposes, and are not used to limit the scope of these messages or information.

The electronic device according to the embodiment of this disclosure belongs to the same inventive concept as the multimedia material editing and processing method according to the above embodiment, and the technical details not described in detail in this embodiment may be found in the above embodiment, and this embodiment has the same beneficial effects as the above embodiment.

An embodiment of the present disclosure provides a computer storage medium, on which a computer program is stored, which, when executed by a processor, implements the multimedia material editing processing method provided in the above embodiment.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: determining editing state description information that is stored corresponding to a third editing state when a target editing task is switched from a first editing state to a second editing state, wherein the third editing state is a first type of editing state that is not triggered after the second editing state among editing states in a preset editing state sequence, the target editing task is a multimedia material editing task, and the preset editing state sequence is used for recording different editing states triggered in sequence in the target editing task in an orderly manner; there is at least one reference editing state in the preset editing state sequence, editing state description information that is stored corresponding to the reference editing state belongs to a second type of editing state description information, and the second type of editing state description information is used for indicating an editing state difference between the second type of editing state and an adjacent editing state triggered before the second type of editing state in the preset editing state sequence; and presenting an editing effect corresponding to the second editing state, according to editing state description information that is stored corresponding to the third editing state.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit can also be described as “a unit that acquires at least two Internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for editing and processing multimedia material, comprising:
determining editing state description information corresponding to a third editing state when a editing task is switched from a first editing state to a second editing state, wherein the third editing state is a first type of editing state that is not triggered after the second editing state among editing states in a preset editing state sequence, the editing task is a multimedia material editing task, and the preset editing state sequence is used for recording different editing states triggered in sequence in the editing task in an orderly manner; there is at least one reference editing state in the preset editing state sequence, editing state description information corresponding to the reference editing state belongs to a second type of editing state description information, and the second type of editing state description information is used for indicating an editing state difference between the second type of editing state and an adjacent editing state triggered before the second type of editing state in the preset editing state sequence; and
presenting an editing effect corresponding to the second editing state, according to editing state description information corresponding to the third editing state.

2. The method according to claim 1, wherein the editing state description information corresponding to the third editing state belongs to a first type of editing state description information, and the first type of editing state description information has an ability to independently present an editing effect generated by a triggered editing operation in the editing state.

3. The method according to claim 1, wherein the switching from the first editing state to the second editing state is a switching triggered by performing an undoing operation on a reference change operation or a switching triggered by performing a redoing operation on the reference change operation after undoing the reference change operation, and the reference change operation is an operation of changing an editing result by performing an editing operation on a multimedia material in a multimedia material editing process.

4. The method according to claim 1, wherein the determining editing state description information corresponding to a third editing state comprises:
searching the third editing state from editing states included in the preset editing state sequence, according to an order of the editing states in the preset editing state sequence; and
obtaining the editing state description information corresponding to the third editing state from the editing state description information corresponding to the editing states in the preset editing state sequence.

5. The method according to claim 1, wherein when the third editing state is the second editing state and belongs to the first type of editing state, the presenting an editing effect corresponding to the second editing state, according to editing state description information corresponding to the third editing state comprises:
directly loading the editing state description information corresponding to the third editing state, and generating and presenting an editing page including the editing effect corresponding to the second editing state.

6. The method according to claim 1, wherein when the third editing state is the first type of editing state triggered before the second editing state among the editing states included in the preset editing state sequence and the second editing state does not belong to the first type of editing state, the presenting an editing effect corresponding to the second editing state, according to editing state description information corresponding to the third editing state comprises:
determining editing state description information corresponding to at least one candidate editing state, wherein the candidate editing state is an editing state that is triggered after the third editing state and not triggered after the second editing state among the editing states included in the preset editing state sequence, the second editing state is an editing state located at an end of a sorting of the at least one candidate editing state, and there is at least one editing state in the at least one candidate editing state, editing state description information corresponding to which belongs to the second type of editing state description information; and
based on the editing state description information corresponding to the third editing state, gradually loading the editing state description information corresponding to each candidate editing state according to an order of at least one candidate editing state in the preset editing state sequence until the loading of the editing state description information corresponding to the second editing state is completed, and generating and presenting an editing page including the editing effect corresponding to the second editing state.

7. The method according to claim 6, wherein when the third editing state is the first type of editing state that is triggered before the second editing state and is closest to the second editing state among the editing states included in the preset editing state sequence and the second editing state does not belong to the first type of editing state, the at least one candidate editing state belongs to the second type of editing state.

8. The method according to claim 1, wherein a preset number of the second type of editing states are configured between two closest first type of editing states in the preset editing state sequence, a value of the preset number is determined based on a size of memory resources allocated for multimedia editing tasks, and the size of the memory resources allocated for the multimedia editing tasks is negatively correlated with the value of the preset number.

9. The method according to claim 1, wherein before the determining editing state description information corresponding to a third editing state, the method further comprises:
determining first editing task information when the editing task is in a fourth editing state, wherein the first editing task information is capable of supporting independent description of an editing result generated by a triggered editing operation for the editing task in the fourth editing state, and the fourth editing state belongs to the first type of editing state in the preset editing state sequence;
determining second editing task information when the editing task is in a fifth editing state, wherein the second editing task information is capable of supporting independent description of an editing result generated by a triggered editing operation for the editing task in the fifth editing state, and the fifth editing state is the second type of editing state, which is triggered after the editing operation is continuously triggered for the editing task already in the fourth editing state and is adjacent to the fourth editing state; and
comparing the second editing task information with the first editing task information to determine editing state description information corresponding to the fifth editing state.

10. The method according to claim 9, wherein the comparing the second editing task information with the first editing task information to determine editing state description information corresponding to the fifth editing state comprises:
traversing to obtain each item of reference function module data in the second editing task information and each item of reference function module data in the first editing task information and performing an item-by-item comparison, wherein the second editing task information and the first editing task information are configured to use the same type of reference function attribute field to describe the same item of reference function module data; and
determining the editing state description information corresponding to the fifth editing state based on an item-by-item comparison result of each item of reference function module data in the second editing task information and each item of reference function module data in the first editing task information.

11. An electronic device, comprising:
at least one processor; and
a storage apparatus configured to store at least one program,
wherein the at least one program, when executed by the at least one processor, cause the at least one processor to implement a multimedia material editing and processing method, which comprises:
determining editing state description information corresponding to a third editing state when a editing task is switched from a first editing state to a second editing state, wherein the third editing state is a first type of editing state that is not triggered after the second editing state among editing states in a preset editing state sequence, the editing task is a multimedia material editing task, and the preset editing state sequence is used for recording different editing states triggered in sequence in the editing task in an orderly manner; there is at least one reference editing state in the preset editing state sequence, editing state description information corresponding to the reference editing state belongs to a second type of editing state description information, and the second type of editing state description information is used for indicating an editing state difference between the second type of editing state and an adjacent editing state triggered before the second type of editing state in the preset editing state sequence; and
presenting an editing effect corresponding to the second editing state, according to editing state description information corresponding to the third editing state.

12. The electronic device according to claim 11, wherein the editing state description information corresponding to the third editing state belongs to a first type of editing state description information, and the first type of editing state description information has an ability to independently present an editing effect generated by a triggered editing operation in the editing state.

13. The electronic device according to claim 11, wherein the switching from the first editing state to the second editing state is a switching triggered by performing an undoing operation on a reference change operation or a switching triggered by performing a redoing operation on the reference change operation after undoing the reference change operation, and the reference change operation is an operation of changing an editing result by performing an editing operation on a multimedia material in a multimedia material editing process.

14. The electronic device according to claim 11, wherein the determining editing state description information corresponding to a third editing state comprises:
searching the third editing state from editing states included in the preset editing state sequence, according to an order of the editing states in the preset editing state sequence; and
obtaining the editing state description information corresponding to the third editing state from the editing state description information corresponding to the editing states in the preset editing state sequence.

15. The electronic device according to claim 11, wherein when the third editing state is the second editing state and belongs to the first type of editing state, the presenting an editing effect corresponding to the second editing state, according to editing state description information corresponding to the third editing state comprises:
directly loading the editing state description information corresponding to the third editing state, and generating and presenting an editing page including the editing effect corresponding to the second editing state.

16. The electronic device according to claim 11, wherein when the third editing state is the first type of editing state triggered before the second editing state among the editing states included in the preset editing state sequence and the second editing state does not belong to the first type of editing state, the presenting an editing effect corresponding to the second editing state, according to editing state description information corresponding to the third editing state comprises:
determining editing state description information corresponding to at least one candidate editing state, wherein the candidate editing state is an editing state that is triggered after the third editing state and not triggered after the second editing state among the editing states included in the preset editing state sequence, the second editing state is an editing state located at an end of a sorting of the at least one candidate editing state, and there is at least one editing state in the at least one candidate editing state, editing state description information corresponding to which belongs to the second type of editing state description information; and
based on the editing state description information corresponding to the third editing state, gradually loading the editing state description information corresponding to each candidate editing state according to an order of at least one candidate editing state in the preset editing state sequence until the loading of the editing state description information corresponding to the second editing state is completed, and generating and presenting an editing page including the editing effect corresponding to the second editing state.

17. The electronic device according to claim 16, wherein when the third editing state is the first type of editing state that is triggered before the second editing state and is closest to the second editing state among the editing states included in the preset editing state sequence and the second editing state does not belong to the first type of editing state, the at least one candidate editing state belongs to the second type of editing state.

18. The electronic device according to claim 11, wherein a preset number of the second type of editing states are configured between two closest first type of editing states in the preset editing state sequence, a value of the preset number is determined based on a size of memory resources allocated for multimedia editing tasks, and the size of the memory resources allocated for the multimedia editing tasks is negatively correlated with the value of the preset number.

19. The electronic device according to claim 11, wherein before the determining editing state description information corresponding to a third editing state, the method further comprises:
determining first editing task information when the editing task is in a fourth editing state, wherein the first editing task information is capable of supporting independent description of an editing result generated by a triggered editing operation for the editing task in the fourth editing state, and the fourth editing state belongs to the first type of editing state in the preset editing state sequence;
determining second editing task information when the editing task is in a fifth editing state, wherein the second editing task information is capable of supporting independent description of an editing result generated by a triggered editing operation for the editing task in the fifth editing state, and the fifth editing state is the second type of editing state, which is triggered after the editing operation is continuously triggered for the editing task already in the fourth editing state and is adjacent to the fourth editing state; and
comparing the second editing task information with the first editing task information to determine editing state description information corresponding to the fifth editing state.

20. A non-transitory computer-readable storage medium, comprising computer-executable instructions, wherein the computer-executable instructions, when executed by a computer processor, perform a multimedia material editing and processing method, which comprises:
determining editing state description information corresponding to a third editing state when a editing task is switched from a first editing state to a second editing state, wherein the third editing state is a first type of editing state that is not triggered after the second editing state among editing states in a preset editing state sequence, the editing task is a multimedia material editing task, and the preset editing state sequence is used for recording different editing states triggered in sequence in the editing task in an orderly manner; there is at least one reference editing state in the preset editing state sequence, editing state description information corresponding to the reference editing state belongs to a second type of editing state description information, and the second type of editing state description information is used for indicating an editing state difference between the second type of editing state and an adjacent editing state triggered before the second type of editing state in the preset editing state sequence; and
presenting an editing effect corresponding to the second editing state, according to editing state description information corresponding to the third editing state.
